(19) United States
(12) Patent Application Publication
(10) Pub. No.: US 2010/0091859 A1
(43) Pub. Date: Apr. 15, 2010

(54) MOTION COMPENSATION APPARATUS AND A MOTION COMPENSATION METHOD

(76) Inventors: Shao-Yi Chien, Taipei (TW); Yi-Nung Liu, Taipei (TW); Ling-Hsiu Huang, Sinshih Township (TW)

Correspondence Address: HAYES SOLOWAY P.C., 3450 E. SUNRISE DRIVE, SUITE 140, TUCSON, AZ, 85718, US

(21) Appl. No.: 12/248,445

(22) Filed: Oct. 9, 2008

(51) Int. Cl. H04N 7/26

(52) U.S. Cl. 375/240.16; 375/E07.123

(57) ABSTRACT

A motion compensation apparatus and a motion compensation method are provided. The motion compensation apparatus comprises: a memory, a motion vector generator, a deviation calculator, a determining module, a selector and a motion compensator. The memory stores a plurality of frame encode information and a plurality of decoded frames; the motion vector generator generates a motion vector according to the plurality of frame encode information; the deviation calculator calculates a deviation data according to the motion vector and the plurality of decoded frames; the determining module determines a confidence level of the motion vector according to the deviation data; the selector selects a plurality of pixels from the plurality of decoded frames according to the motion vector when the confidence level is high; and the motion compensator compensates the plurality of decoded frames according to the plurality of pixels.

### BACKGROUND

1. Field of Invention

The present invention relates to a motion compensation apparatus. More particularly, the present invention relates to a motion compensation apparatus and a motion compensation method.

2. Description of Related Art

Motion compensation is an important issue in image processing. In decode process, the prediction of the motion vectors in a series of frames is highly related to the motion compensation. The accuracy of the prediction determines the quality of the motion compensation. If the motion vectors are reliable, the motion compensation process making use of the motion vector results in high quality compensated frames. If the motion vectors are unreliable, the motion compensation process making use of the motion vector results in great deviation compared to the original frames.

Nevertheless, not every motion vectors in a series of frames is the same. For example, if there is a dramatic movement between two frames, a deviation of the prediction of the motion vector occurs. Thus, it's important to figure out when the motion vectors predicted during the decode process is accurate to get high quality motion compensated frames.

Accordingly, what is needed is a motion compensation apparatus and a motion compensation method to determine when the motion vector is reliable to overcome the above issues. The present invention addresses such a need.

### SUMMARY

A motion compensation apparatus and a motion compensation method are provided. The motion compensation apparatus comprises: a memory, a motion vector generator, a deviation calculator, a determining module, a selector and a motion compensator. The memory stores a plurality of frame encode information and a plurality of decoded frames; the motion vector generator generates a motion vector according to the plurality of frame encode information; the deviation calculator calculates a deviation data according to the motion vector and the plurality of decoded frames; the determining module determines a confidence level of the motion vector according to the deviation data; the selector selects a plurality of pixels from the plurality of decoded frames according to the motion vector when the confidence level is high; and the motion compensator compensates the plurality of decoded frames according to the plurality of pixels.

Another object of the present invention is to provide a motion compensation method comprising the steps of: generating a motion vector according to a plurality of frame encode information and a plurality of decoded frames; calculating a deviation data according to the motion vector and the plurality of decoded frames; determining a confidence level of the motion vector; selecting a plurality of pixels from the plurality of decoded frames according to the motion vector when the confidence level is high; and compensating the plurality of decoded frames according to the plurality of pixels.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a motion compensation apparatus of the first embodiment of the present invention;

FIG. 2 is a flow chart of the second embodiment of the present invention;

FIG. 3 is a block diagram of a motion compensation apparatus of the first embodiment of the present invention; and

FIG. 4 is a flow chart of the fourth embodiment of the present invention;

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

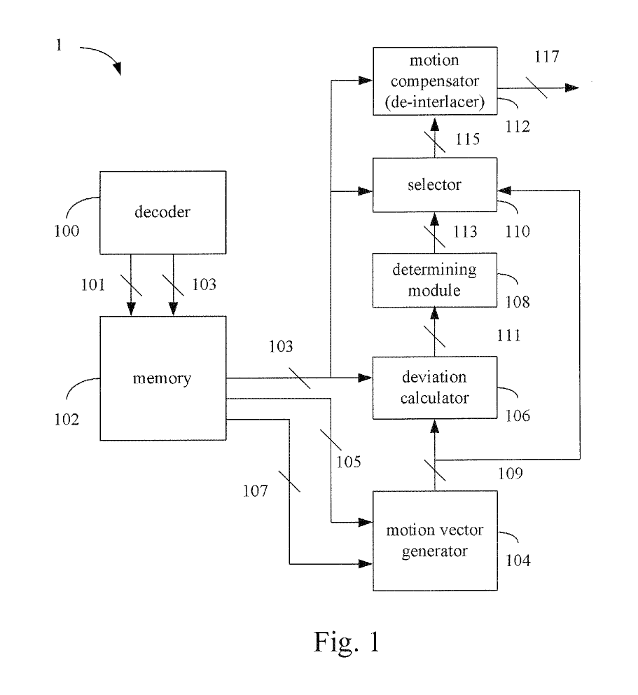

Please refer to FIG. 1, a block diagram of a motion compensation apparatus 1 of the first embodiment of the present invention. The motion compensation apparatus 1 comprises: a decoder 100, a memory 102, a motion vector generator 104, a deviation calculator 106, a determining module 108, a selector 110 and a motion compensator 112. The memory 102 stores a plurality of frame encode information 101 and a plurality of decoded frames 103, wherein the plurality of frame encode information 101 and the plurality of decoded frames 103 are received from the decoder 100. The plurality of frame encode information 101 comprise a residue information 105 and an encode mode information 107. The motion vector generator 104 generates a motion vector 109 according to the plurality of frame encode information 101. The motion vector 109 records the motion of the objects between two frames. The deviation calculator 106 further calculates a deviation data 111 according to the motion vector 109 and the plurality of decoded frames 103. The determining module 108 determines a confidence level of the motion vector 109 according to the deviation data 111. If the determining result is a high confidence level 113, the motion vector 109 is considered to be reliable. The selector 110 then selects a plurality of pixels 115 from the plurality of decoded frames 103 according to the motion vector 109. The motion compensator in the present embodiment is a de-interlacer 112. The de-interlacer 112 de-interlace each of the decoded frames 103 according to the plurality of pixels 115 selected from the decoded frame needed to perform the de-interlaced process to generate a plurality of de-interlaced frames 117 and further raise the resolution of each frames.

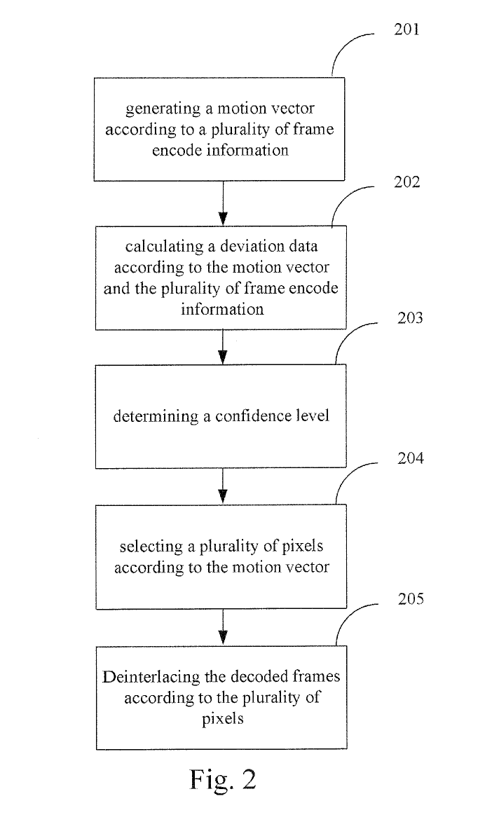

FIG. 2 is a flow chart of the second embodiment of the present invention. The second embodiment is a motion compensation method comprising the following steps. In step 201, generating a motion vector according to a plurality of frame encode information and a plurality of decoded frames; in step 202, calculating a deviation data according to the motion vector and the plurality of decoded frames; then in step 203, determining a confidence level of the motion vector; in step 204, selecting a plurality of pixels from the plurality of decoded frames according to the motion vector when the confidence level is high; then in step 205, compensating the plurality of decoded frames by de-interlacing each of the decoded frames according to the plurality of pixels.

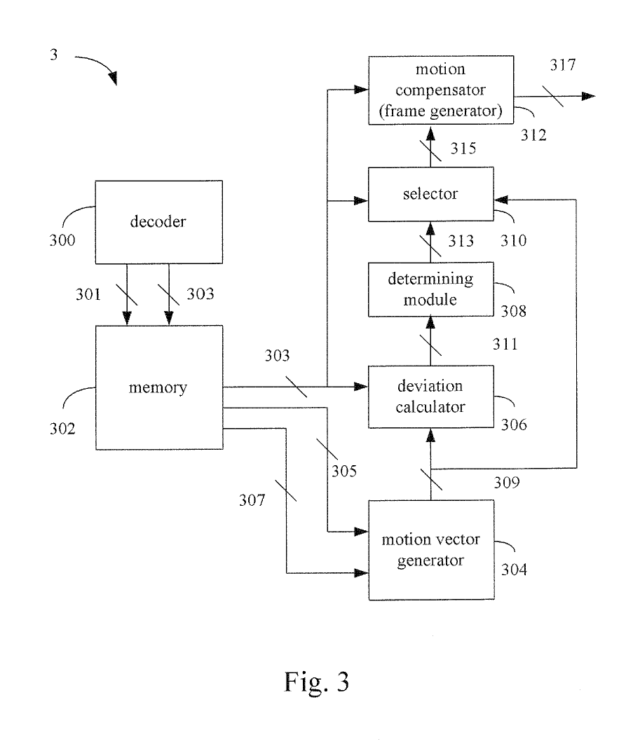

The third embodiment of the present invention is depicted in FIG. 3, a block diagram of a motion compensation apparatus 3. The motion compensation apparatus 3 comprises a decoder 300, a memory 302, a motion vector generator 304, a deviation calculator 306, a determining module 308, a selector 310 and a motion compensator 312. The only difference between the first and the third embodiment is the motion compensator 312. The motion compensator 312 of the present invention is a frame generator 312 to up-convert the frame rate of the decoded frames. Each of the motion vectors generated by the motion vector generator 304 corresponds to a pair of decoded frames. When the determining result of the determining module 308 is a high confidence level 313, the frame generator 312 generates an interpolated frame 317 between each pair of the decoded frames to raise the frame rate according to a plurality of pixels 315 from the plurality of decoded frames 303 selected by the selector 310 according to the motion vector 309.

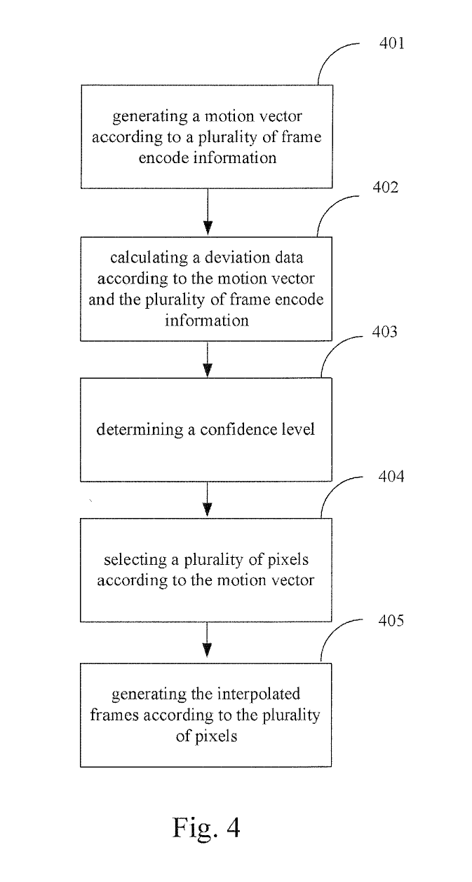

FIG. 4 is a flow chart of the fourth embodiment of the present invention. The fourth embodiment is a motion compensation method comprising the following steps. In step 401, generating a motion vector according to a plurality of frame encode information and a plurality of decoded frames; in step 402, calculating a deviation data according to the motion vector and the plurality of decoded frames; then in step 403, determining a confidence level of the motion vector; in step 404, selecting a plurality of pixels from the plurality of decoded frames according to the motion vector when the confidence level is high; then in step 405, compensating the plurality of decoded frames by generating an interpolated frame between each pair of the decoded frames.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A motion compensation apparatus comprises:
a memory to store a plurality of frame encode information and a plurality of decoded frames;
a motion vector generator to generate a motion vector according to the plurality of frame encode information;
a deviation calculator to calculate a deviation data according to the motion vector and the plurality of decoded frames;
a determining module to determine a confidence level of the motion vector according to the deviation data;
a selector to select a plurality of pixels from the plurality of decoded frames according to the motion vector when the confidence level is high; and
a motion compensator to compensate the plurality of decoded frames according to the plurality of pixels.

2. The motion compensation apparatus of claim 1, wherein the memory receives the plurality of frame encode information and the plurality of decoded frames from a decoder.

3. The motion compensation apparatus of claim 1, wherein the plurality of frame encode information comprise a residue information and an encode mode information.

4. The motion compensation apparatus of claim 3, wherein the motion vector generator generates the motion vector according to the residue information and the encode mode information.

5. The motion compensation apparatus of claim 1, wherein the motion compensator is a de-interlacer to de-interlace each of the decoded frames according to the plurality of pixels to generate a plurality of de-interlaced frames.

6. The motion compensation apparatus of claim 1, wherein the motion compensator is a frame generator to generate an interpolated frame between every two decoded frames according to the plurality of pixels.

7. A motion compensation method comprises the steps of:
generating a motion vector according to a plurality of frame encode information and a plurality of decoded frames;
calculating a deviation data according to the motion vector and the plurality of decoded frames;
determining a confidence level of the motion vector;
selecting a plurality of pixels from the plurality of decoded frames according to the motion vector when the confidence level is high; and
compensating the plurality of decoded frames according to the plurality of pixels.

8. The motion compensation method of claim 7, wherein the plurality of frame encode information and the plurality of decoded frames are from a decoder.

9. The motion compensation method of claim 7, wherein the plurality of frame encode information comprise a residue information and an encode mode information.

10. The motion compensation method of claim 7, wherein the motion vector is generated according to the residue information and the encode mode information.

11. The motion compensation method of claim 7 wherein the compensating step is to de-interlace each of the decoded frames according to the plurality of pixels.

12. The motion compensation method of claim 7 wherein the compensating step is to generate an interpolated frame between every two decoded frames according to the plurality of pixels.
